(19) United States
(12) Patent Application Publication
(10) Pub. No.: US 2015/0317634 A1
(43) Pub. Date: Nov. 5, 2015

(54) SECURE TEXT INITIATED PAYMENT PROCESSING SYSTEM

(71) Applicant: Fredrick Hugo Robinson Angoy, Glen Mills, PA (US)

(72) Inventor: Fredrick Hugo Robinson Angoy, Glen Mills, PA (US)

(21) Appl. No.: 14/267,071

(22) Filed: May 1, 2014

(51) Int. Cl. G06Q 20/40

(52) U.S. Cl. CPC G06Q 20/4012

(57) ABSTRACT

To process a secure payment transaction, a payment processing system receives a request for an authorization code for an authorized payment amount from a payor's electronic device, verifies the payor's identity, generates an authorization code for a payment transaction, stores the authorization code in association with the authorized payment amount, and sends the authorization code to a mobile device associated with the payor. When the system receives, from a third party payee, a request for payment comprising a requested payment amount and a verification code, the system determines whether the verification code and the requested payment match the authorization code and the authorized amount. The system transmits an instruction to proceed with the payment in the authorized payment amount to the third party payee only if the verification code and the requested payment match the authorization code and the authorized amount.

### BACKGROUND

Payment systems have evolved significantly over the years as various complex trading systems developed. With the ever-increasing popularity of the Internet and of Internet commerce, both consumers and sellers are using the Internet to facilitate financial transactions between parties. In on-line financial transactions, consumers may use third-party payment service providers to transfer money through electronic communications with others over electronic networks, such as the Internet. The money transfer may be for payment of goods or services or between family members and friends. The third-party payment providers provide an infra-structure, software, and services that enable users to make and receive payments. The payments may be credit card payments, electronic bank transfers, or other payment techniques offered by the third-party payment provider.

With increased use and proliferation of mobile devices in Internet commerce, SMS (Short Messaging Service) or text transactions are becoming prevalent. However, current third party payment service providers require the user to perform a series of steps such as registering with the service provider, providing a username and password, and the like, before a transaction may be processed. Such steps are cumbersome to perform on a mobile device which often times has a small form factor keypad. Moreover, text messages can be intercepted and even manipulated, and customers are generally wary of exchanging sensitive financial information over texts.

Hence, there is a need for a simple and fast, yet secure system and method to perform financial transactions between users using mobile and other computing devices.

### SUMMARY

In a general aspect, the embodiments disclose a payment processing system containing a non-transitory, computer readable memory, one or more processors, and a computer-readable medium processes a secure payment transaction. The method of processing the secure payment transaction includes receiving a request for an authorization code for an authorized payment amount from an electronic device of a payor, verifying the payor's identity, generating a first authorization code, storing the first authorization code in association with the authorized payment amount, sending the first authorization code to a mobile device associated with the payor, and receiving a request for payment from a third party payee, wherein the request includes a requested payment amount, a payor identifier and a second authorization code. The method further includes transmitting an instruction to process the payment in the authorized payment amount to the third party payee if the second authorization code matches the first authorization code and the requested payment amount is less than or equal to the authorized payment amount, otherwise denying payment to the third party payee.

In some embodiments, the receipt of request for the first authorization code for the authorized payment amount may include receiving one or more text messages from the electronic device of the payor.

The method may also include parsing the request for the first authorization code for the authorized payment amount to ascertain a unique identifier associated with the payor. Alternatively or in addition, if the method includes parsing the request for the first authorization code for the authorized payment amount to ascertain a unique identifier associated with the payor, the method may include using the unique identifier to ascertain the mobile device associated with the payor, and also optionally using the ascertained mobile device associated with the payor when sending the first authorization code. Alternatively or in addition, the method may also include using the unique identifier associated with the payor for verifying the payor's identity by using the unique identifier to ascertain the mobile device associated with the payor, generating a telephone call to the mobile device, receiving a personal identification code from the payor over the telephone call, and verifying that the received personal identification code matches an expected personal identification code for the payor. In some embodiments, the unique identifier may be a phone number.

In some embodiments, sending the first authorization code to the mobile device associated with the payor may include sending a text message to the mobile device.

Optionally, the method may also include sending a first confirmation message to the payor and a second confirmation message to the payee, wherein each of the first confirmation message and the second confirmation message include information regarding the processed payment. Alternatively or in addition, the second confirmation message may include the payor's shipping address.

In another general aspect, the embodiments disclose a method of processing a secure transfer of funds. The method includes, by a processor, receiving, from an electronic device of a payor, a request comprising a unique identifier, an authorized amount and a transferee account number, verifying the payor's identity, wherein the verifying comprises: ascertaining the mobile device associated with the payor using the unique identifier, generating a telephone call to the mobile device, receiving a personal identification code from the payor over the telephone call, and determining whether the received personal identification code matches an expected personal identification code for the payor. The method further includes transmitting an instruction to proceed with the transfer of funds to the transferee account number in the authorized amount if the received personal identification code matches the expected personal identification code for the payor, otherwise denying transfer to the transferee account number.

In another general aspect, the embodiments disclose a method of processing a purchase order from a product catalog. The method includes, by a processor, receiving, from an electronic device of a customer, a request comprising a unique identifier and a purchase order, verifying the customer's identity, wherein the verifying comprises: ascertaining the mobile device associated with the customer using the unique identifier, generating a telephone call to the mobile device, receiving a personal identification code from the customer over the telephone call, and determining whether the received personal identification code matches an expected personal identification code for the customer. The method further includes transmitting an instruction to proceed with the purchase order if the received personal identification code matches the expected personal identification code for the customer, otherwise denying the purchase order to the transferee account number. In some embodiments, the instruction to proceed with the purchase order includes an instruction to process the order and send order information to a vendor. Optionally and/or in addition the method may include receiving tracking information regarding a shipment package from the vendor and directing delivery to the customer. In some embodiments, directing delivery to the customer may include sorting the shipment package, and generating a repackaging label and a delivery instruction.

### BRIEF DESCRIPTION OF THE DRAWINGS

FIG. 1 is a schematic diagram depicting the interaction between a text initiated payment processing system (TIPS), a payor, and a payee according to an embodiment.

FIG. 2A depicts a flow chart example of a process generating the authorization code for a payor in a TIPS subsystem according to an embodiment.

FIG. 2B depicts a flow chart example of a process for payment to a payee in a TIPS subsystem according to an embodiment.

FIG. 3 is a swim lane diagram showing interactions between a TIPS, a payor, and a payee according to an embodiment.

FIG. 4 depicts a flow chart example of a process for using the TIPS for processing a transfer of funds.

FIG. 5 depicts a flow chart example of a process for using the TIPS for processing a purchase order form a catalog.

FIG. 6 depicts various embodiments of a computing device for implementing the various methods and processes described in this document.

### DETAILED DESCRIPTION

This disclosure is not limited to the particular systems, methodologies or protocols described, as these may vary. The terminology used in this description is for the purpose of describing the particular versions or embodiments only, and is not intended to limit the scope.

As used in this document, any word in singular form, along with the singular forms “a,” “an” and “the,” include the plural reference unless the context clearly dictates otherwise. Unless defined otherwise, all technical and scientific terms used in this document have the same meanings as commonly understood by one of ordinary skill in the art. All publications mentioned in this document are incorporated by reference. Nothing in this document is to be construed as an admission that the embodiments described in this document are not entitled to antedate such disclosure by virtue of prior invention. As used in this document, the term “comprising” means “including, but not limited to.”

A “mobile device” or “mobile electronic device” refers to a portable computing device that includes a processor and non-transitory, computer-readable memory. The memory may contain programming instructions in the form of a software application that, when executed by the processor, causes the device to send/receive SMS or another like text message service or protocol according to the programming instructions. Examples of suitable portable electronic devices include smartphones, personal digital assistants, tablet devices, electronic readers, personal computers, media players, satellite navigation devices and the like.

A “payor” is a customer, having a mobile device, and conducting a transaction, wherein the “transaction” involves transfer of funds from or at the direction of the payor to a payee, and the “payee” is the recipient of the funds. The transaction may be a payment for the purchase of goods or services. In certain embodiments, the transaction may be an online transfer of funds from one account to another. The transaction may be domestic and/or international.

Accounts as discussed here may include an account with a central payment system such as a micro-payment system. They may also include bank accounts, such as accounts from which a central payment system may deposit or remove funds. In addition, the account may be a credit or debit account, such as an account relating to a credit or debit card. The size of the payment and the type of goods or services handled by the payment can vary widely. Although limits may be appropriate in certain cases, such as for security measures that a user or the system may impose, in other instances, such limits may be increased or removed.

Although this disclosure primarily refers to “funds” or “money” transfer, it is not limited to transfers of cash or cash equivalents, though such representations of money would generally be part of one implementation of the system. Rather, points or other representations of value may also be included under the identification of funds or money. Also, indirect transfers of funds or money are also contemplated, so that various payment schemes may be used to match the payment or receipt methods preferred by particular users. For example, one user may choose to have an account directly with a central payment system, while another user may prefer to have an account with a third party, to which the central system (which would be part of the larger payment system that includes the third party) could transmit funds. (The central payment system may itself have an account or other relationship with the third party for making such transfers.)

The general purpose of the present disclosure is to provide a system and/or method that allows payors to securely pay for goods and/or services, or carry out commercial or other similar transactions in real time using mobile telephones or other similar devices using text message (e.g., via a short message service (SMS), WhatsApp, iMessage or the like) instructions.

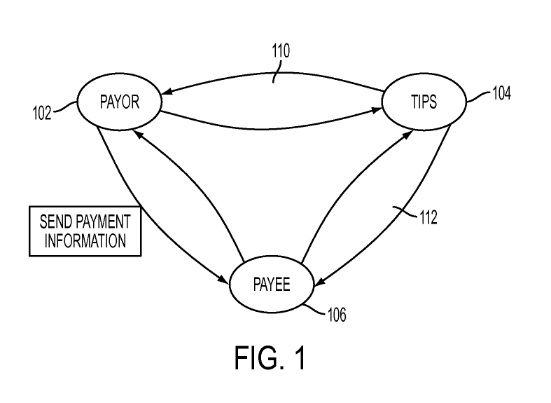

FIG. 1 shows schematically one embodiment of a payment system depicting the interaction between a secure text initiated processing system (TIPS), a payor, and a payee, where the payor initiates a request. The TIPS 104 may communicate with a payor 102, using an electronic device, and process 110. In certain embodiments, the electronic device may be a mobile device and communications are via text messages conveyed over a communications network. In some embodiments, process 110 may involve generation of an authorization code. The TIPS 104 may be located at a bank or other financial institution or may be an independent institution. The TIPS 104 may also communicate with a payee 106 over a communications network using process 112. In some embodiments, process 112 may involve receipt of payment by the payee. The payor 102 may communicate with the payee 106 over a communications network to send and/or receive information. The information may include order for goods and/or services, payor identification information, payment information or the like. The communications network may be a combination of one or more of a cellular network, internet, intranet, wireless network, LAN and the like, operated according to principles known in the art. The communications network may use various security protocols known in the art such as secure socket layer (SSL) connection and the like in order to protect payor and/or payee confidential information. In certain embodiments, the payor 102 may communicate with the payee 106 personally (i.e., without the use of a communications network).

In certain embodiments, the TIPS 104 may include one or more communication servers (not shown here) that may be programmed to send and/or receive specifically formatted commands. In some embodiments, the communication servers may include text communication servers programmed to send and/or receive specifically formatted texts. In certain other embodiments, the communication servers may include interactive voice response (IVR) servers that may be programmed to interact with a payor and/or a payee, for example, via a telephone call placed to and/or from the IVR to a device such as a mobile phone.

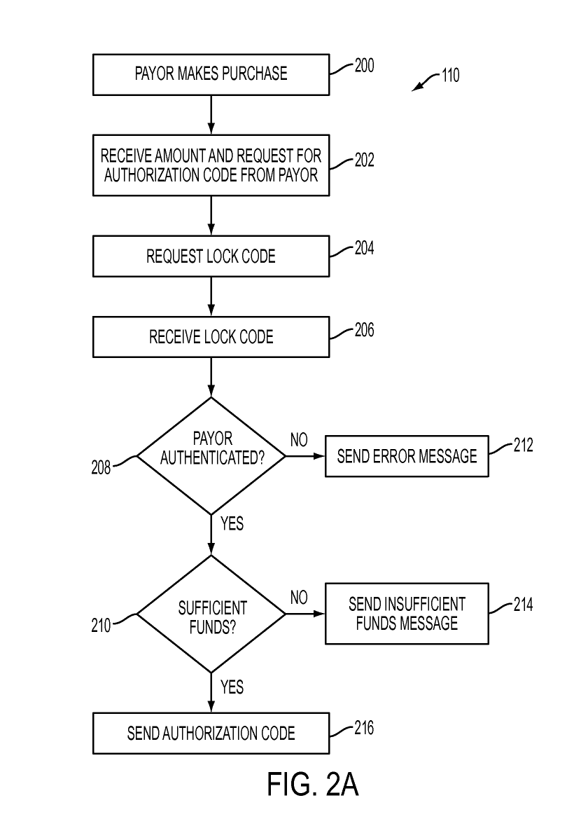

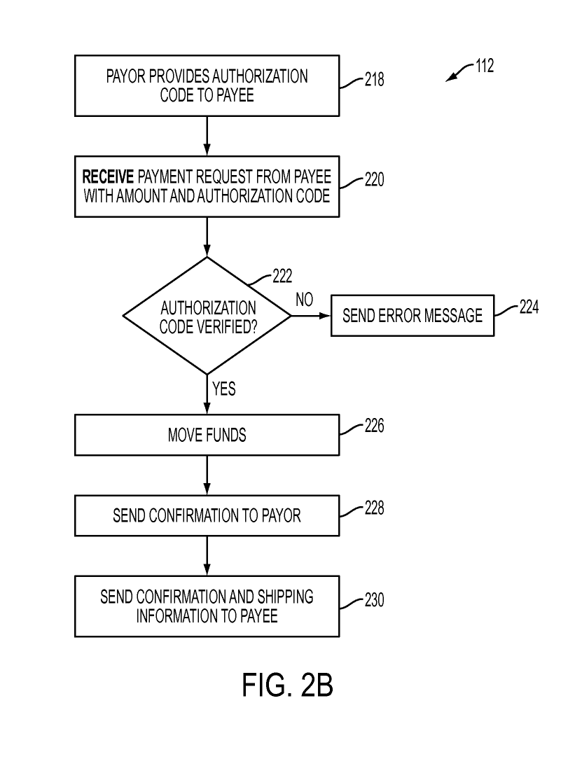

FIG. 2A depicts a flow chart example of a process 110 for generating the authorization code for a payor in a TIPS subsystem according to an embodiment. The process may start when the payor makes a purchase 200 and selects the TIPS as the payment method. At step 202, the payor may transmit a message to the TIPS to generate an authorization code for transfer of a requested amount to a payee. The message may be generated as part of a simple text message having a predetermined format or formats entered by the user, and transmitted to a text message address designated to the TIPS. The format may take, for example, the following format:

“AUT<space and/or special character>dollar amount”

For example, the payor may want to generate an authorization code for the purchase of goods and/or service worth two hundred dollars. The payor may thus type and send the following text message: AUT*200 to the TIPS text message address.

The initial term or prefix (in this example, “AUT”) indicates to the message receiving processor, of the text message, that the message is intended for the generation of an authorization code. Thus, when the message is received by the system and initially parsed, the general text messaging intake system can use the prefix to quickly determine that the message (or information from the message) should be forwarded to the authorization code generation system. The message receiving processor may or may not be a part of the TIPS system. Various formats may be generated in order to distinguish the different services offered by the TIPS. Therefore, the format of the message may indicate to a messaging intake system what service the message is intended for. For example,

“REC<space and/or special character>payment amount” may be used for crediting a customer's account using a credit or debit card.

“TRN<space and/or special character>payee's identifying information <space and/or special character>payment amount” may be used for transfer of funds from one account to another. E.G. “TRN*1234567890*25”

In certain embodiments, messages may be sent to different text message addresses for different services. Where the text messaging intake address is dedicated to a particular service, an identifier for the particular service may not be necessary.

Upon receipt of the text message, the system may parse the message, and may extract, store, and/or analyze the relevant content. The parsing may occur in a separate messaging system (e.g., in a front-end system) or in the TIPS (after the message has been forwarded). Unique identifying information about the payor may be obtained, e.g., from the message header, and may be used to identify the payor, and an account of the payor to be debited. In certain embodiments, the unique identifying information may be the payor's phone number. In certain other embodiments, the payor's phone number may be retrieved after a payor has been identified using the unique identifying information, by accessing a database of stored phone numbers associated with the payors.

In certain embodiments, in addition to or as an alternative to requesting the authorization code via SMS message, in step 202, the payor may call the TIPS IVR servers to request an authorization code. The IVR servers may be programmed to guide the payor through the requisition process by prompting the payor to identify the required service and enter the dollar amount. For example, the IVR servers may give the payor a list of available services, each associated with a number, and ask the payor to enter the number associated with the desired service followed by a dollar amount and the pound sign using a mobile device keypad.

At step 204, the TIPS may prompt the communications server to obtain authentication credentials from the payor, and may request the payor to provide a payor specific account lock code (or password, or PIN number, or similar entry) to verify payor identity. The TIPS may also receive the payor's phone number as part of the message that requests the code. In certain embodiments, the lock code may be requested using the TIPS IVR servers. The IVR servers may be programmed to call the identified payor on a number previously assigned to the payor, followed by a prompt for the user to key or speak the lock code. The use of IVR servers further protects the payor from fraud and theft. In certain embodiments, a payor initiated call to the TIPS IVR servers may be used to request the lock code. In certain embodiments, the payor may initiate a call to the TIPS IVR servers to request an authorization code.

After the payor provides the lock code at step 206, the TIPS may authenticate the payor and payor account at step 208 by, for example, verifying that the lock code match a previously stored lock code for the identified payor. The authentication step, in some embodiments, may be by association with an account at the TIPS that belongs to the payor. In certain other embodiments, the verification step may also include an additional security step including the identification of device with a particular payor, such as by verifying the phone number of the device from which the message requesting the authorization code originated.

If the system determines in step 208 that the lock code does not match, then it may generate an error message (212) and it may prompt the payor to provide the correct lock code. The system may repeat the process for a finite number of times, example 2-3 times, to account for user errors, and to allow the transaction to be carried out. If the correct code is not retrieved after an allowed number of attempts, the payor may be prevented from completing the transaction by denying an authorization code.

Optionally, if the system determines in step 208 that the lock code matches, then the TIPS in step 210 may verify that the payor account has sufficient funds to cover the amount requested, and if there are sufficient funds present, may generate and store an authorization code. The TIPS may then transmit the authorization code to the payor in step 216 via a text message. However, if the system determines in step 210, that the available funds are insufficient to cover the amount requested then it may transmit a message indicating insufficient funds to the payor at step 214. In certain embodiments, the authorization code may be set to expire after a set time if unused.

FIG. 2B depicts a process for payment to a payee in a TIPS subsystem according to an embodiment. The payor may provide the authorization code (for the specified dollar amount) received from the TIPS subsystem in an online or personal transaction to a payee at step 218. The payee may then submit a payment request over a communications network to the TIPS by submitting at least the authorization code, the payor's identifying information, and the requested dollar amount in step 220. In certain embodiments, the payor's identifying information may be the payor's phone number. In an embodiment, the payee may access the TIPS using a protocol such as a WSDL (web services definitional language), SOAP (simple object access protocol), API (application program interface), or the like. The applications may be initiated from a remote call procedure from an API or other protocol. The remote calls may be initiated from a program resident on a user device or from a third-party platform or website, or any other website that may feature access to a payment provider service application. The service application may be configured to provide and display payment services mechanism or mechanisms, such as an image, icon, radio button, dialogue box or other graphical user interface (GUI) on a display component (e.g., monitor) accessible to the payee. For example, the TIPS may include an API designed to gather the requisite information from the payee. This may be of any desired form but in this case includes the payee, amount to be paid, authorization code and the payor phone number. It may also include the due date and additional payment instructions.

The TIPS, at step 222, may identify the transaction based on the payor identifying information provided by the payee, and may authenticate the transaction by matching the authorization code to a code in a repository of previously stored authorization codes. The TIPS may further verify the authenticity of the code by matching the payor identifying information provided by the payee with the payor information previously stored. The TIPS may further verify that the payment amount requested is less than or equal to the amount authorized by the payor. If the TIPS either cannot match the authorization code, cannot verify the amount, or cannot verify the payor identifying information associated with the authorization code, it may generate an error message (step 224) prompting the payee to recheck the information provided. The system may repeat this process for a finite number of times, for example 2-3 times, to account for user errors. If the system cannot retrieve the correct match after an allowed number of attempts, it may prevent the payee from completing the transaction.

Optionally, if the TIPS verifies the authorization code and the payment amount step 222, then it may process the transaction and effect a transfer of funds, in step 226, in the requested amount from the payor's account to the payee's account. This processing may occur in real time, in batches or in any other desired manner.

Once the transaction is completed, the authorization code expires and may not be used again.

The amount credited and the amount debited can be different amounts. For example, a processing fee may be deducted from a transaction or added to amounts taken from payor's account. Other fees may also be assessed to various accounts, either in association with a particular transaction or otherwise (e.g., for penalties, withholding for taxes, or for other services). The terms of such fees or withholdings may be agreed to by the parties, such as when users initially open accounts, methods for which are well known in the art.

Once the transaction has been processed, the TIPS may send notification messages to the payor (step 228) and/or the payee (step 230) that the requested funds have been transferred. The confirmation messages may take any appropriate form. For example, a message may be in the form of a simple text message indicating that a certain amount of funds have been debited from the payor's account or credited to the payee's account. The message may also include text allowing a confirmation, such as a URL, to be shown. For example, a web page that allows more detailed follow up for the transaction. In certain embodiments, a shipping address of the payor may be provided to the payee to complete the purchase order. The confirmatory information may also be limited, such as for security purposes.

In certain embodiments, the payor may choose to pay multiple payees using a single message. The syntax of the message sent by the payor's mobile device may permit for such payments, such as by stringing together multiple identification numbers.

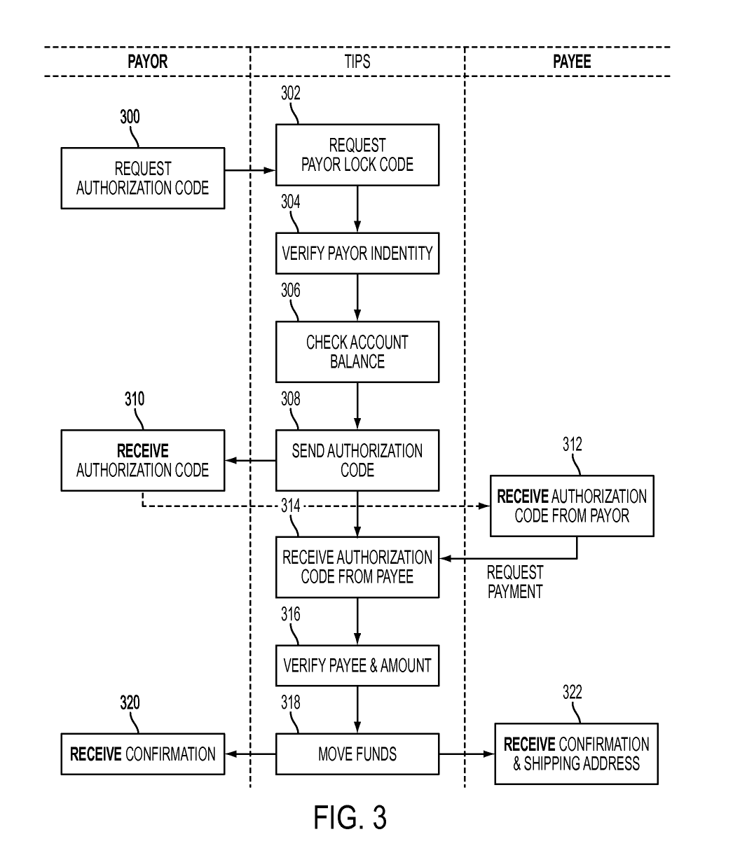

FIG. 3 is a swim lane diagram showing interactions between a payor and a payee, and TIPS. The steps of the process here are similar to those in earlier-depicted flows. The payor may send a request for an authorization code with an amount to the TIPS in step 300. Upon receipt of the request, the TIPS in step 302 may request the payor to provide the lock code, and as discussed previously verify payor identity in step 304, based on the lock code and the phone number from which the request originated. The TIPS may then check the account balance, credit limit, or other similar threshold to determine if there are sufficient funds available to the payor to cover the amount requested in step 306, and if the system determines that there are sufficient funds, then it may send the authorization code to the payor in step 308. Upon receipt of the authorization code from the TIPS (310), the payor may then provide the authorization code to the payee (312). The payee may transmit a request for payment and the received authorization code, along with the payor identifying information such as the payor phone number to the TIPS (314). TIPS, in step 316, may verify the payor phone number, authorization code and payment amount requested (discussed previously), and upon verification move funds from the payor's account to the payee in step 318. The payor and the payee may receive confirmation of the transaction from the TIPS in steps 320 and 322, respectively.

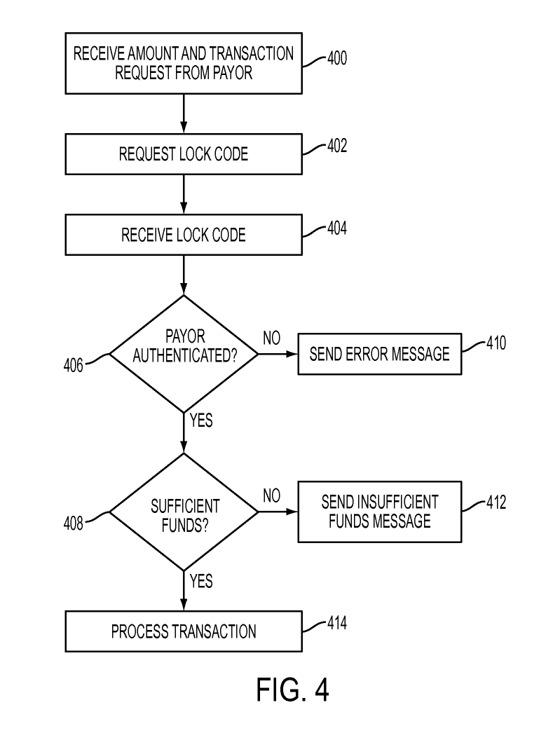

FIG. 4 depicts the utilization of the TIPS for more direct banking operations, such as funds transfers and other payments in banking via text messaging without the generation of an authorization code. At step 400, to initiate the process, the payor may transmit a message to the TIPS to process a transaction in a certain amount. As discussed previously with respect to FIG. 2A, the message may be generated as part of a simple text message having a predetermined format or formats entered by the user, and transmitted to a text message address designated to the TIPS. For example, the payor may transmit a message providing an instruction, an account number, and an amount. As one example, a funds transfer may be formatted as:

“TRN<space and/or special character>account number <space and/or special character>payment amount” may be used for transfer of funds from payor's account to the account number provided in the message. For example, if the payor wants to transmit $375 to account number 12345, the payor may type and send the following message TRN 12345 375.

As discussed previously with respect to FIG. 2A, upon initial parsing, the message receiving processor may determine that the format is for transfer of funds and notify the TIPS as such. Various formats may be generated in order to distinguish the different services offered by the TIPS. In certain embodiments, the transaction involving a transfer of funds may be processed without the generation of an authorization code. Upon receipt of the message providing the above instruction, the TIPS, in step 402 may call the payor using IVR to request the lock code. Upon receipt of the lock code (404), if the TIPS authenticates the received lock code in step 406, and determines that sufficient funds are present (408), it may directly process the transfer of funds (414) and transfer the authorized amount from the payor's account to the account number provided in the message. TIPS may also send confirmation messages to the payor and the payee.

However, if the TIPS cannot authenticate the lock code, it may generate an error message (410), and prompt the payor to provide the correct lock code. The TIPS may repeat this process for a finite number of times, example 2-3 times, to account for user errors, and allow the transaction to be carried out. If the system cannot retrieve the correct code after an allowed number of attempts it may prevent the payor from completing the transaction by denying an authorization code. If at step 408, the TIPS determines that funds are insufficient to cover the transaction amount, it may generate an “insufficient funds” message in step 412.

As discussed previously, in certain embodiments, the payor may call the TIPS IVR servers to request the transaction. The IVR server may be programmed to guide the payor through the process by prompting the payor to identify the required service and enter the dollar amount. The payor initiated phone call may then be used by the TIPS to request the lock code.

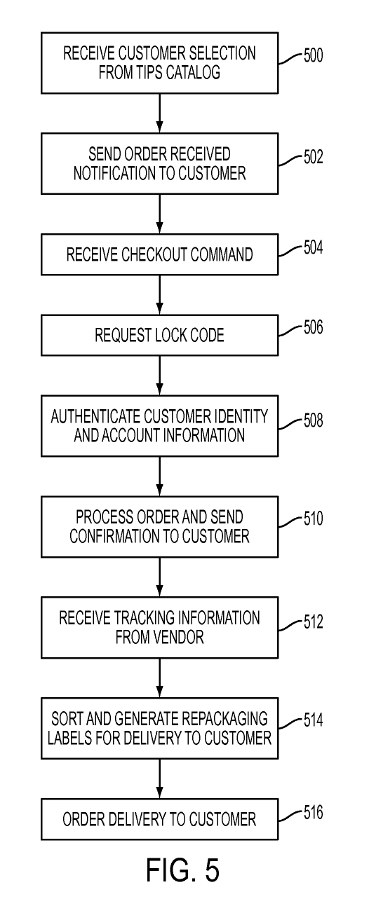

FIG. 5 depicts the utilization of the TIPS for processing customer purchase orders from a TIPS catalog. In an embodiment, the catalog may include a listing of products from one or more vendors, description of products, purchase price of products, availability information, estimated shipping time, and other such information. At step 500, the payor may transmit a message to the TIPS to purchase a desired product from the TIPS catalog. As discussed previously with respect to FIG. 2A, the message may be generated as part of a simple text message having a predetermined format or formats entered by the user, and transmitted to a text message address designated to the TIPS. For example, the payor may transmit a message providing a service identifier, product identifier, and a desired quantity. As one example, an order may be formatted as:

“CAT<space and/or special character>ADD<space and/or special character>quantity<space and/or special character>product identifier” may be used for adding a desired quantity of a product from the catalog to the customers shopping cart. For example, if the payor wants to buy 6 of a product listed in the catalog having a product identifier 22-875490, the payor may type and send the following message CAT*ADD*6*22-875490. Various formats may be generated to allow the user to order more than one type of product at the same time, cancel previously ordered items, or perform similar other tasks.

As discussed previously with respect to FIG. 2A, upon initial parsing, the message receiving processor may determine that the format is for ordering a product from the TIPS catalog and notify the TIPS as such. In certain embodiment, the customer may also access the TIPS catalog using a protocol such as a WSDL (web services definitional language), SOAP (simple object access protocol), API (application program interface), or the like. The applications may be initiated from a remote call procedure from an API or other protocol. The remote calls may be initiated from a program resident on a user device or from a third-party platform or website, or any other website that may feature access to a catalog order service application. The service application may be configured to provide and display catalog ordering services mechanism or mechanisms, such as an image, icon, radio button, dialogue box or other graphical user interface (GUI) on a display component (e.g., monitor) accessible to the customer. For example, TIPS may include an API designed to gather the requisite information from the customer.

Upon receipt of the message providing the above instruction, at step 502 the TIPS may then notify the customer that the order has been received at TIPS. As discussed previously with respect to FIG. 2A, the TIPS may derive customer specific information, such a phone number, by parsing the message. The TIPS may then send a message to the customer in step 502 notifying the customer that the order was received (including the order details) at the TIPS, and may receive a checkout command in response at step 504. The checkout command may verify that the identified customer had placed the correct order, and may notify the TIPS to proceed with the order. Upon receipt of the checkout, the TIPS, in step 506 may call the payor using IVR to request the lock code. Upon receipt of the lock code, the TIPS system may further authenticate the customer identity and verify customer account information (508) by matching the lock code to a previously stored lock code in association with the identified customer, as discussed previously. In certain embodiments, the customer may place the order by placing a call to the TIPS IVR servers, which may then guide the customer through steps 502 to 506. In certain other embodiments, the TIPS may call the customer using IVR in step 502 and guide the customer through steps 504 and 506 in a single call. Upon verification, at step 510, TIPS may process the order by sending the order information to a vendor, and sending a confirmation message to the customer. The vendor may then ship the ordered product to a TIPS warehouse, and send tracking information to the TIPS system in step 512. In certain embodiments, the vendor may directly ship the ordered product to the customer. In certain embodiments, the TIPS warehouse where the order is received may be a TIPS warehouse closest (in distance) from the vendor. The TIPS may then monitor the tracking history of the package and upon registering receipt of the product to the TIPS warehouse, sort the order information, generate repackaging labels for delivery to the customer, and transmit a command for delivery of the ordered product to the customer in step 514. In certain embodiments, the TIPS system may direct the repackaged order to a TIPS distribution center in step 514. Upon receipt of the order at the TIPS distribution center, the TIPS may then direct delivery to the customer in step 516.

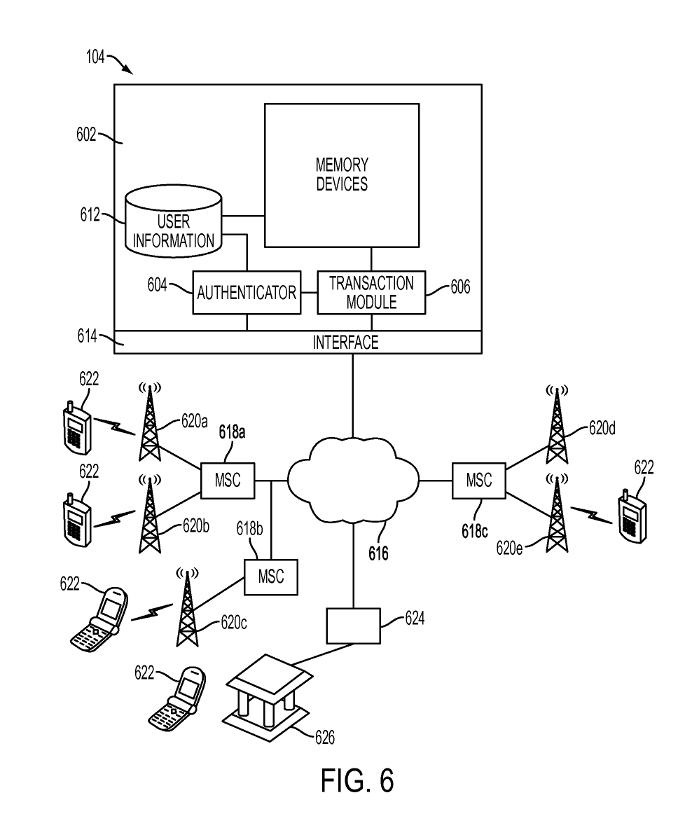

FIG. 6 is a schematic representation of a secure text initiated processing system (TIPS) 104, which may permit users of electronic devices, such as mobile devices, to transfer funds to users of other devices via simple means, such as via SMS text messaging. The system 104 may act on accounts internal to a single system, and may also act on, or provide fund transfers with, other accounts such as external bank accounts, debit accounts, or credit (e.g., credit card) accounts, among others.

In some embodiments, TIPS may include one or more application programming interfaces (APIs) in order to communicate with the payor and/or payee.

The system 104 includes a payment processor 602, which may include a number of server computers connected to a communications network 616 such as internet. Payment processor 602 may include, for example, one or more web servers, financial servers, and related hardware and software to receive and interpret orders for the transfer of funds, verify and carry out the transfer, notify parties to the transaction, and permit for various forms of analysis and follow-up.

Payment processor 602 is a central processing unit of the system, performing calculations and logic operations required to execute a program. Payment processor, alone or in conjunction with one or more of the other elements, is a processing device, computing device or processor as such terms are used within this disclosure. As used in this document and in the claims, the term “processor” may refer to a single processor or any number of processors in a set of processors. Read only memory (ROM) and random access memory (RAM) constitute examples of memory devices. Additional memory devices may include, for example, an external or internal disk drive, a hard drive, flash memory, a USB drive or another type of device that serves as a data storage facility. As indicated previously, these various drives and controllers are optional devices. Additionally, the memory devices may be configured to include individual files for storing any software modules or instructions, auxiliary data, incident data, common files for storing groups of contingency tables and/or regression models, or one or more databases for storing the information as discussed above.

Program instructions, software or interactive modules for performing any of the functional steps associated with the processes as described above may be stored in the ROM and/or the RAM. Optionally, the program instructions may be stored on a non-transitory, computer readable medium such as a compact disk, a digital disk, flash memory, a memory card, a USB drive, an optical disc storage medium, and/or other recording medium.

Payment processor 602 receives messages from, and sends messages to, a variety of devices on a number of different networks. For example, mobile devices 622 of various forms may communicate using one or more cellular telephone data networks. The networks may take a typical form, including by communication through towers 620a, 620b, and 620c, in communication with various mobile switching centers 618a, 618b, and 618c which may in turn be connected to a central telephone network (not shown) and to the internet 616. Other appropriate configurations of data networks, including wireless data networks, may also be used.

Separately, a financial services processor 626 may be accessed through a financial gateway or router 624. Communications with financial services processor 626 may be encrypted or otherwise protected for security (as may other communications in the system). Although financial services processor 626 is shown connected to the payment processor 602 through the internet (which may be carried out with encryption and other similar features), it may also connect through a private network (not shown) to provide additional security.

Payment processor 602 receives and sends messages through interface 614, which may be comprised of one or more web servers and/or text message servers.

Payment processor 602 may be part of a larger information service provider system that provides services in addition to payment processing, such as search services, mapping, e-commerce, web content delivery, and other on-line services. Thus, interface 614 can be provided with structures for identifying messages relating to payment processing and properly routing such messages or information from such messages. For example, the larger system may accept any sort of SMS text message, and may be provided with a parser to break messages into pieces that can serve as variables for later actions relating to the message. In addition, the parser may obtain information from the text message header. Suitable parsers are well known in the art.

Information from messages that have been identified as being payment-related messages may be forwarded to an authenticator 604. The authenticator 604 may draw upon a database of user information 612 to check whether information identified in the incoming message is accurate and can be acted upon. Authenticator 604 may transmit information to a transaction module 606 which is responsible for effecting a funds transfer, and for confirming the transaction with the users.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A method of processing a secure payment transaction, the method comprising, by a processor:
receiving, from an electronic device of a payor, a request for an authorization code for an authorized payment amount;
ascertaining a unique identifier associated with the payor by parsing the request for the first authorization code for the authorized payment amount;
verifying the payor's identity using the unique identifier;
generating a first authorization code for a payment transaction;
storing the first authorization code in association with the authorized payment amount;
sending the first authorization code to a mobile device associated with the payor;
receiving, from a third party payee, a request for payment, wherein the request comprises a payor identifier, a requested payment amount and a second authorization code;
determining whether the second authorization code matches the first authorization code, and whether the requested payment amount is less than or equal to the authorized payment amount; and
if the second authorization code matches the first authorization code, and the requested payment amount is less than or equal to the authorized payment amount, then transmitting an instruction to process the payment in the authorized payment amount to the third party payee, otherwise denying payment to the third party payee.

2. The method of claim 1, wherein receiving the request for the first authorization code for the authorized payment amount comprises receiving one or more text messages from the electronic device of the payor.

3. (canceled)

4. The method of claim 1, wherein sending the first authorization code to the mobile device associated with the payor comprises ascertaining the mobile device associated with the payor using the unique identifier.

5. The method of claim 1, wherein verifying the payor's identity using the unique identifier comprises:
ascertaining the mobile device associated with the payor using the unique identifier;
automatically generating a telephone call to the mobile device;
receiving a personal identification code from the payor over the telephone call; and
verifying that the received personal identification code matches an expected personal identification code for the payor.

6. The method of claim 1, wherein the unique identifier is a phone number.

7. The method of claim 1, wherein sending the first authorization code to the mobile device associated with the payor comprises sending a text message to the mobile device.

8. The method of claim 1, further comprising, by the processor, sending a first confirmation message to the payor and a second confirmation message to the payee, wherein each of the first confirmation message and the second confirmation message comprise information regarding a status of the payment transaction.

9. The method of claim 8, wherein the second confirmation message further comprises a shipping address for the payor.

10. A payment processing system comprising:
a non-transitory, computer readable memory;
one or more processors; and
a computer-readable medium containing programming instructions that, when executed by the one or more processors, cause the system to:
receive, from an electronic device of a payor, a request for a first authorization code for an authorized payment amount;
ascertain a unique identifier associated with the payor by parsing the request for the first authorization code for the authorized payment amount;
verify the payor's identity using the unique identifier;
generate a first authorization code for a payment transaction;
store the first authorization code in association with the authorized payment amount in the memory;
send the first authorization code to a mobile device associated with the payor;
receive, from a third party payee, a request for payment, wherein the request comprises a payor identifier, a requested payment amount and a second authorization code;
determine whether the second authorization code matches the first authorization code, and whether the requested payment amount is at most less than or equal to the authorized payment amount; and
if the second authorization code matches the first authorization code, and the requested payment amount is at most less than or equal to the authorized payment amount, then transmit an instruction to process the payment in the authorized payment amount to the third party payee, otherwise deny payment to the third party payee.

11. The payment processing system of claim 10, wherein the instructions to receive a request for the first authorization code for the authorized payment amount comprise instructions to receive one or more text messages from the electronic device of the payor.

12. (canceled)

13. The payment processing system of claim 10, wherein the instructions to send the first authorization code to the mobile device associated with the payor comprise instructions to ascertain the mobile device associated with the payor using the unique identifier.

14. The payment processing system of claim 10, wherein the instructions to verify the payor's identity comprise instructions to:
ascertain the mobile device associated with the payor using the unique identifier;
automatically generate a telephone call to the mobile device;
receive a personal identification code from the payor over the telephone call; and
verify that the received personal identification code matches an expected personal identification code for the payor.

15. The payment processing system of claim 10, wherein the unique identifier is a phone number.

16. The payment processing system of claim 10, wherein the instructions to send the first authorization code to the mobile device associated with the payor comprise instructions to send a text message to the mobile device.

17. The payment processing system of claim 10, further comprising additional programming instructions that when executed, cause the processor to send a first confirmation message to the payor and a second confirmation message to the payee, wherein each of the first confirmation message and the second confirmation message comprise information regarding a status of the payment transaction.

18. The payment processing system of claim 17, wherein the second confirmation message further comprises a shipping address for the payor.

19. A method of processing a secure transfer of funds, the method comprising, by a processor:
receiving, from an electronic device of a payor, a request comprising a unique identifier, an authorized amount and a transferee account number;
verifying the payor's identity, wherein the verifying comprises:
ascertaining the mobile device associated with the payor using the unique identifier,
generating a telephone call to the mobile device,
receiving a personal identification code from the payor over the telephone call, and
determining whether the received personal identification code matches an expected personal identification code for the payor; and
if the received personal identification code matches the expected personal identification code for the payor, then transmitting an instruction to proceed with the transfer of funds to the transferee account number in the authorized amount, otherwise denying transfer to the transferee account number.

20. The method of claim 19, further comprising, by the processor, sending a first confirmation message to the payor and a second confirmation message to a transferee, wherein each of the first confirmation message and the second confirmation message comprise information regarding the transfer of funds.

21. A method of processing a purchase order from a product catalog, the method comprising, by a processor:
receiving, from an electronic device of a customer, a request comprising a unique identifier and a purchase order;
verifying the customer's identity, wherein the verifying comprises:
ascertaining the mobile device associated with the customer using the unique identifier,
generating a telephone call to the mobile device,
receiving a personal identification code from the customer over the telephone call, and
determining whether the received personal identification code matches an expected personal identification code for the customer; and
if the received personal identification code matches the expected personal identification code for the customer, then transmitting an instruction to proceed with the purchase order, otherwise denying the purchase order to the transferee account number.

22. The method of claim 21, wherein the instruction to proceed with the purchase order comprises an instruction to process the purchase order and send order information to a vendor.

23. The method of claim 21, further comprising receiving tracking information regarding a shipment package from the vendor and directing delivery to the customer.

24. The method of claim 23, wherein directing delivery to the customer further comprises sorting the shipment package, and generating a repackaging label and a delivery instruction.
